(19) United States
(12) Patent Application Publication
(10) Pub. No.: US 2022/0128825 A1
(43) Pub. Date: Apr. 28, 2022

(54) Augmented Reality with a Wearable Eye Glasses Device

(71) Applicant: Christopher M. KALAFATAS, Hull, MA (US)

(72) Inventor: Christopher M. KALAFATAS, Hull, MA (US)

(21) Appl. No.: 17/502,703

(22) Filed: Oct. 15, 2021

Related U.S. Application Data
(60) Provisional application No. 63/104,018, filed on Oct. 22, 2020.

(51) Int. Cl. G02B 27/01; G02B 27/00; G06T 19/00; H04W 4/80

(52) U.S. Cl. CPC G02B 27/0176; G02B 27/0101; G02B 27/0172; G02B 2027/0178; G06T 19/006; H04W 4/80; G02B 2027/0138; G02B 27/0093

(57) ABSTRACT

A system and methods of using same, including a wearable eye glasses device having a frame and a neck-strap. The frame has a front-piece carrying at least two cameras on at least one side of the frame, and transparent augmented reality eye lenses for both eyes. The device further includes wireless communication such as a Bluetooth interface and/or a Wi-Fi interface, and an energy source such as a battery preferably held in the neck-strap, which can also carry additional components as selected to provide desired capabilities.

### CROSS-REFERENCE TO RELATED APPLICATION

This application claims the benefit of U.S. Provisional Patent Application No. 63/104,018 filed 22 Oct. 2020. The entire contents of the above-mentioned application are incorporated herein by reference.

### FIELD OF THE INVENTION

This invention relates to user devices facilitating remote interactive systems and more particularly to wearable technology enabling augmented reality interactions.

### BACKGROUND OF THE INVENTION

A common difficulty encountered by a person at a location is when that person seeks information and/or guidance on a topic from another person who is more knowledgeable on that topic but is in a different physical location. The inquiring person can be considered to be “local” while the more knowledgeable person is “remote” from the inquiring person. The inquiring person may try to explain his or her situation over the phone, or even send a photo electronically to the more knowledgeable person, also, referred to as an “expert”, but the expert then has a challenge communicating instructions or guidance back to the inquiring person.

One system utilizing augmented reality, also referred to as AR, to enhance interactions over distances is disclosed in U.S. Pat. No. 9,846,972 by Montgomerie et al. Other remote technical guidance and/or education systems are disclosed in U.S. Pat. No. 8,758,021 by Takahashi and U.S. Patent Application Publ. No. 2018/0203238 A1 by Smith, J R., for example. Some systems may be rather complex and relatively expensive.

There have been remarkable advances in wearable technology, including the Google Glass Explorer and Enterprise Editions with optical head-mounted display. Miniaturized equipment for receiving and transmitting sound is found in the BOSE Sport Bluetooth Sunglasses, for example.

It is therefore desirable to provide a simplified augmented reality system with wearable technology that encourages its use and enhances interactions with others.

### SUMMARY OF THE INVENTION

An object of the present invention is to provide wearable technology to a wide variety of users who want to train/learn, gain experience and/or guidance, and otherwise better his or her life.

Another object of the present invention is to accelerate and enhance education, guidance and experience in real time.

This invention features a system and methods of using same, including a wearable eye glasses device having a frame and a neck-strap. The frame has a front-piece carrying at least two cameras on at least one side of the front-piece, preferably on both sides of the front-piece, and transparent augmented reality eye lenses for both eyes. The frame includes right and left arms bendably connected at their front ends to the front-piece, preferably by a hinge or other flexible member, and having middle portions which rest over ears of a user. Rear portions of the arms connect to opposite ends of the neck-strap. One or both of the frame and the neck-strap preferably carry wireless communication equipment such as a Bluetooth interface and/or a Wi-Fi interface, and an energy source such as a battery preferably held in the neck-strap, plus additional electrical components as desired for selected capabilities.

Visual data, preferably with audio data, is transmitted to and from the wearable device over the internet to a secure website that allows an instructor, a guide or other expert to see a user's field of view. Preferably, a video return feed from the expert is provided substantially in real time allowing the expert to draw, circle, annotate, and/or add text over the user's video feed then transmit mark-ups back to the user's device. The mark-ups are superimposed over the user's field of view.

In a number of embodiments, the device further includes at least one microphone, eye movement tracking sensor, and/or other components such as earpieces. In certain embodiments, the neck-strap is removably securable to the frame.

In some embodiments, the device preferably has an on/off switch or other mechanism for energizing its components from the energy source and, in certain embodiments, has a transmit/receive button or other mechanism to temporarily transmit and/or receive data.

### BRIEF DESCRIPTION OF THE DRAWINGS

In what follows, preferred embodiments of the invention are explained in more detail with reference to the drawings, in which:

FIG. 1 is a schematic front view of a front-piece of a wearable eye glasses device according to the present invention;

FIG. 2 is a schematic diagram illustrating how a user UR wearing the device of

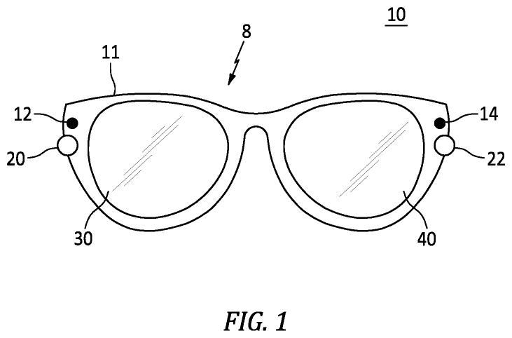

FIG. 1 can communicate with and expert EX; and

FIG. 3 is a schematic perspective view of another embodiment of a wearable eye glasses device according to the present invention showing a frame and a neck-strap connected to hinged arms of the frame, containing at least one battery in a housing, and connected to at least one wired ear-piece.

### DETAILED DESCRIPTION OF THE PRESENTLY PREFERRED EMBODIMENTS

This invention may be accomplished by a device, and a system and methods of using same, comprising a wearable eye glasses device having a frame and a neck-strap. The frame has a front-piece carrying components including at least two cameras on at least one side of a frame, preferably on both sides of the frame, and a transparent augmented reality eye lens for each eye. In one embodiment, the device further includes a microphone, eye movement tracking sensor, wireless communication such as a Bluetooth interface and/or a Wi-Fi interface, and an energy source such as a battery. One or more components preferably are held in the neck-strap, also referred to herein as a neck band, and which, in some constructions, is removably securable to flexible and/or hinged arms of the frame. The device preferably has an on/off switch or other mechanism for energizing its components from the energy source and, in some constructions, has a transmit/receive button or other mechanism to temporarily transmit and/or receive visual and/or audio data.

Visual data, preferably with audio data, is transmitted to and from the wearable device over the internet, either directly via hardware such as a wireless network interface controller or indirectly via a smart phone or other mobile device, to a secure website that allows an instructor, a guide or other expert to see a user's field of view. Preferably, a video return feed from the expert is provided substantially in real time allowing the expert to draw, circle, annotate, and/or add text over the user's video feed then transmit mark-ups back to the user's device. The mark-ups are then superimposed over the user's field of view.

The present invention facilitates and encourages use of wearable technology by the general public to enhance and speed up education, training, knowledge and experience for one or more topics. Whether the topic is job-site training, grade school or college, the office, learning to cook Italian from a woman in Italy, a piece of furniture that you're having trouble building or an emergency. This will help everybody. It's as easy as putting on glasses.

The term “expert” as utilized herein refers to an intelligent source, such as a human or an artificial intelligence operating on a computer or other machine, that is knowledgeable regarding at least one topic. An expert can be a part-time or full-time instructor, a guide, a teacher, or simply an entity who can guide or otherwise inform a user regarding the at least one topic.

The term “user” as utilized herein refers to a person wearing and using a wearable device according to the present invention and includes students, trainees, and other people seeking guidance and/or information from an expert.

The term “camera” as utilized herein refers to an optical imaging device.

The term “generally” as utilized herein refers to at least a majority of a recited feature.

The term “substantially” as utilized herein encompasses deviations of up to ten percent and/or up to several seconds delay in communications, such as “substantially in real time” encompassing deviations up to several seconds in relaying audio and/or visual signals between local users and remote experts.

Device 10 according to the present invention, FIG. 1, has a frame 8 with a front piece 11 which supports equipment such as a right LED (light-emitting diode) light 12, a left LED light 14, a right camera 20, a left camera 22, a right transparent OLED or LCD (liquid crystal device) display lens 30 and a left transparent OLED or LCD display 40. Lenses 30 and 40 preferably provide at least safety protection and may also provide prescriptive correction if a particular user is near-sighted, far-sighted and/or has astigmatism in one or both eyes. Additional desired components including a neck-strap are described below in relation to FIG. 3.

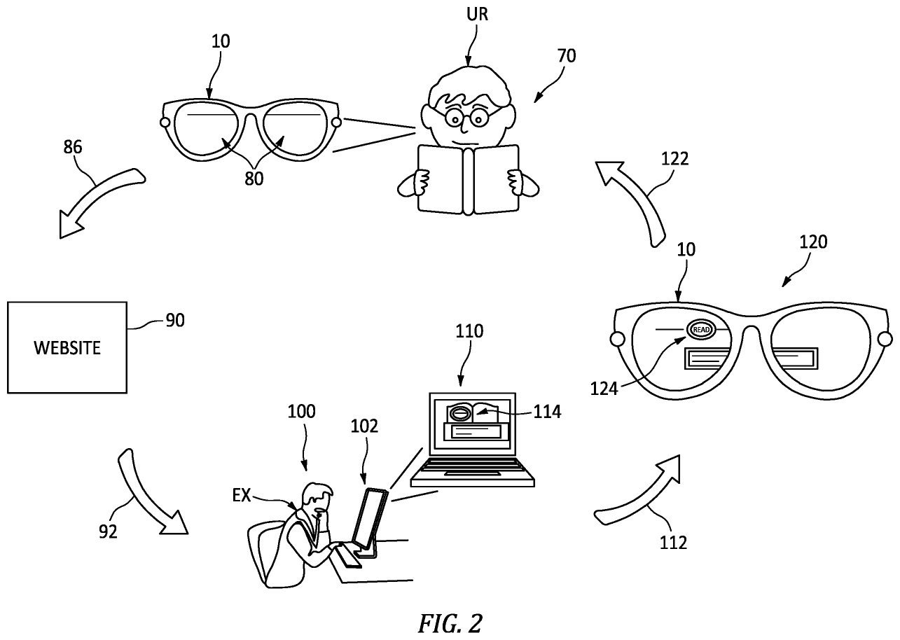

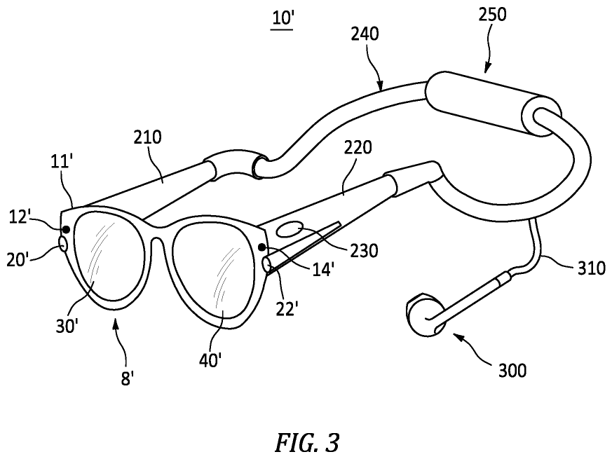

One system and method according to the present invention utilizing device 10 is illustrated in FIG. 2 for a user UR wearing the device 10 and occupying a location 70 while reading a book in this example. If user UR is learning to read, or encounters a word or phrase that he or she does not understand, then the user can wirelessly transmit the current field of view 80, preferably with audio signals as well as visual signals, over the internet, represented by arrow 86, to a secure website 90. If no Wi-Fi is detected, in one construction the device will use built-in Bluetooth or other wireless technology to connect with a smart device of the user to communicate over a cellular network with the website 90.

As one example, the user UR is a student is having trouble with the word “Read”. An expert EX, such as an instructor at a remote location 100 with a computer 102, can access the website 90, as indicated by arrow 92, and then see the student's field of view and hear the student's voice as he reads out loud. Access by the expert EX preferably is achieved in substantially real time, although initially transmissions from the user UR can be stored in storage media in servers hosting the website 90 and/or in computer 102 until the expert EX has the opportunity to interact with the user UR. The expert EX can be a pre-selected instructor requested by the user UR or, in other situations, is someone who is sufficiently knowledgeable on the topic, is currently available, and is matched to the user UR through website 90.

The expert EX is shown logged into the website 90 and can now hear, talk, highlight, circle, point out, add text, or otherwise annotate and comment over the live video feed. For example, the expert EX has circled the word “read” with annotation 114. The website transmits back instructors voice and mark-ups in substantially real time, as indicated by arrow 112, to device 10 to display the instructor's annotations 120, including circle 124 around the word “read”, on the device 10 over the user UR field of view. The student/trainee UR receives annotations, as indicated by arrow 122, over their live field of view at location 70, and can hear instructors voice providing guidance such as “The word is pronounced ‘rEad’, the A is silent.”

Additional desired components for a device 10′ according to the present invention are illustrated in FIG. 3. Front-piece 11′ of frame 8′ supports equipment such as a right LED (light-emitting diode) light 12′, a left LED light 14′, a right camera 20′, a left camera 22′, a right transparent OLED or LCD (liquid crystal device) display lens 30′ and a left transparent OLED or LCD display 40′.

Frame 8′ includes arms 210, 220 which in this construction are movably connected, with hinge mechanisms such as three-piece hinges or living hinges, at their front ends with front piece 11′ . In other constructions, arms 210, 220 are monolithic with front piece 11′ with frame 8′ made of a flexible, bendable and/or resilient material. Middle portions of arms 210, 220, also referred to as temple pieces, rest over the ears of a user. In this construction, rear portions of arms 210, 220 are removably connected to opposite ends of neck-strap 240. One or both of arms 210, 220 can carry additional components such as On/Off, finger touch pad 230 to serve as an on/off switch to energize components of device 10′ from the energy source and, in some constructions as a transmit/receive button or other mechanism to temporarily transmit and/or receive data.

Neck-strap 240 carries, preferably in a concealed manner, any desired wiring, antennas, and electronics that are not otherwise carried within frame 8′. A housing 250 contains at least one battery and Wi-Fi and Bluetooth components. Neck-strap 240 enables a distance to be placed between the brain of the user and electronic components carried in housing 250. In some constructions, neck-strap 240 is formed of a woven fabric such as found in CROAKIES eyewear retainer straps and may have elastic cuffs to augment gripping of the arms 210, 220. A center portion of the neck-strap 240 may have an access flap, preferably releasably closable with Velcro hook-and-loop or other releasable fastener such as a zipper, to provide access to the housing 250 and components contained therein.

Arms 210,220 preferably contain Sensors for Augmented Reality tracking including eye movement sensors, one or more microphones, and finger touch pad on outside. Suitable user-control and user-interface components include those currently found in the Google Glass Explorer and Enterprise Editions and the BOSE Sport Bluetooth Sunglasses, for example.

An earpiece 300 is shown connected to neck-strap 240 by wire 310 in this construction. In other constructions, one or two earpieces are wirelessly connected via Bluetooth with a user's smart phone or other mobile device, which may contain an “app” (software application) that facilitates use of device 10′. In certain constructions, one or more wireless in-ear monitors (IEMs) can be utilized, with a separate transmitter and receiver packages carried in housing 250 or a separate package carried elsewhere by the user and which interface with device 10′. In some constructions, one or more components of existing wearable technology such as an Apple Watch device can be carried within device 10′.

Many trades have experienced a dwindling supply of experienced workers over for the last few decades. The subject invention system trains new workers much faster, enhances supervision, and can employ retirees with decades of experience in specified fields to instruct and guide apprentices. Not only can we help train faster and more reliably but we can also create a whole new industry for retirees or physically impaired individuals with experience in specific fields who can supplement their income while conveying their expertise to others. Certain illustrative examples of uses of the present invention are as follows.

Example 1—A wife asks her husband to get a jar of sauce. The husband goes to a market but can't find that brand or type of sauce, he therefore grabs wrong jar causing an argument. The present system gives the remote person (wife) the ability to point out a suitable container of sauce to her husband through AR by circling, typing, or otherwise pointing to the correct jar.

Example 2—A supervisor in construction is 10 miles away from the Jobsite for a meeting. A construction crew member calls with a question on where exactly he is cutting an access hole into ceiling framing. The supervisor can't see it or explain accurately where it goes, therefore the crew member is told to wait until the supervisor returns to the jobsite.

By comparison, with the technology of the present invention, the crew member could alert the supervisor by contact list in device display or smart phone and send alert notification or, if the crew member has a remote guide, they can alert supervisor directly through contact list found on the website. Supervisor receives alert on smart device and can open an app or website at meeting immediately and see video being broadcasted and can annotate over the video transmitting back to the crew members device exact location of hole. He would also be able to check on work progress whenever needed.

Example 3—With the trades dwindling supply of experienced workers for the last few decades, the present invention can be utilized to train much faster and employ retirees with decades of experience in specified fields to instruct and guide apprentices. As an example, a union apprentice is trained with an instructor directly overseeing the apprentice (in reality it's more like 40 minutes per day), it takes four years (3,120 hours) for the apprentice to gain enough knowledge to become a journeyman. With the present system the apprentice is directly guided/trained every second at the same time the guide/instructor is also watching over the apprentice's safety. The time frame for training with the present system would take the apprentice 1 ½ years instead of three to four or more years to achieve the required 3,120 hours to become a journeyman.

Example 4—A 911 operator receives a call from a bystander about a man who has been has severed an artery in his arm and is bleeding heavily. With our system the 911 operator can instruct, direct, and view in real time how to place a tourniquet on the arm. At the same time the 911 operator can witness how severe the wound is and direct emergency personnel with accurate information cutting down response time.

Example 5—A 911 operator receives a call from a person witnessing a crime. With our system the 911 operator can see and grab a screen shot of criminal and send it to police at the same time the operator is alerting them to a crime and instructing police while watching thru caller's device.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it, is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is, to be understood that the foregoing embodiments are provided as illustrative only, and do not limit or define the scope of the invention. Various other embodiments, including but not limited to the following, are also within the scope of the claims. For example, elements and components described herein may be further divided into additional, components or joined together to form fewer components for performing the, same functions. Any of the functions disclosed herein may be implemented using means for performing, those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on, or executable by, a programmable computer including any combination of any number of the following: a processor, a storage medium readable and/or writable by the processor (including, for example, volatile and non-volatile memory and/or storage elements), an input device, and an output device. The input device and/or the output device form a user interface in some embodiments. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically relay at least specific visual data between a local human and a remote expert, automatically update data in an electronic memory representing such specific visual data, and automatically and wirelessly transmit such data to a server over a digital electronic network for storage and processing. Such features can only be performed by computers and other machines and cannot be performed manually or mentally by humans.

Any claims herein which affirmatively require a computer, a processor, a controller, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a controller, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disk (not shown) or a removable disk or flash memory. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium or other type of user interface. Any data disclosed herein may be implemented, for example, in one or more data structures tangibly stored on a non-transitory computer-readable medium. Embodiments of the invention may store such data in such data structure(s) and read such data from such data structure(s).

It is the intention, therefore, to be limited only as indicated by the scope of the claims appended hereto. Other embodiments will occur to those skilled in the art after reviewing the present disclosure and are within the following claims.

What is claimed is:

1. A system for a user, comprising:
a wearable eye glasses device having a frame and a neck-strap have a first end and a second end, the frame having a front-piece carrying at least two cameras on at least one side of the front-piece, and transparent augmented reality eye lenses for both eyes of the user;
wherein the frame includes right and left arms, each arm (1) bendably connected at a front end to the front-piece, (2) having a middle portion which rest over ears of the user, and (3) a rear portion connected to one of the first end and the second end of the neck-strap; and
at least one of the frame and/or the neck-strap carries (i) wireless communication equipment and (ii) an energy source energetically connected to at least the wireless communication equipment.

2. The system of claim 1 wherein the energy source is a battery held in the neck-strap.

3. The system of claim 1 wherein the wireless communication equipment is configured to transmit at least visual data to and from the wearable device over the internet to a secure website that allows an expert to see the user's field of view.

4. The system of claim 3 wherein a video return feed from the expert is provided substantially in real time allowing the expert to draw, circle, annotate, and/or add text over the user's video feed then transmit mark-ups back to the user's device.

5. The system of claim 4 wherein the mark-ups are superimposed over the user's field of view.

6. The system of claim 5 wherein the device further includes at least one of (i) a microphone, (ii) an eye movement tracking sensor, and/or (iii) at least one earpiece configured to transmit audio signals to the user.

7. The system of claim 2 wherein the neck-strap is removably securable to the frame.

8. The system of claim 7 further including an on/off switch to enable the user to energize at least the wireless communication equipment

9. The system of claim 8 further including a transmit/receive button to enable a user to selectively transmit and/or receive data.

10. A method for enabling a user to interact with a remote expert, comprising:
selecting a wearable eye glasses device having a frame and a neck-strap have a first end and a second end, the frame having a front-piece carrying at least two cameras on at least one side of the front-piece, and transparent augmented reality eye lenses for both eyes of the user;
wherein the frame includes right and left arms, each arm (1) bendably connected at a front end to the front-piece, (2) having a middle portion which rest over ears of the user, and (3) a rear portion connected to one of the first end and the second end of the neck-strap, and at least one of the frame and/or the neck-strap carries (i) wireless communication equipment and (ii) an energy source energetically connected to at least the wireless communication equipment; and
transmitting at least visual data to and from the wearable device over the interne to a secure website that allows the remote expert to see the user's field of view.

11. The method of claim 10 further including providing a video return feed from the remote expert substantially in real time allowing the expert to draw, circle, annotate, and/or add text over the user's video feed then transmit mark-ups back to the user's device.

12. The method of claim 11 wherein the mark-ups are superimposed over the user's field of view.

13. The method of claim 12 wherein the device is selected to include at least one of (i) a microphone, (ii) an eye movement tracking sensor, and/or (iii) at least one earpiece configured to transmit audio signals to the user.
